(19) United States
(12) Patent Application Publication
(10) Pub. No.: US 2015/0172467 A1
(43) Pub. Date: Jun. 18, 2015

(54) USING VIRTUAL SUBSCRIBER IDENTIFIERS IN COMMUNICATION SYSTEMS

(71) Applicant: Snypir Inc., Redwood City, CA (US)

(72) Inventor: Alexandr Kotin, Dmitrov (RU)

(73) Assignee: Snypir Inc., Redwood City, CA (US)

(21) Appl. No.: 14/109,036

(22) Filed: Dec. 17, 2013

(51) Int. Cl. H04M 7/12; H04M 7/00; H04L 29/12; H04M 3/42

(52) U.S. Cl. CPC H04M 7/128; H04M 3/42306; H04M 7/0006; H04L 61/106

(57) ABSTRACT

Systems and methods for using virtual subscriber identifiers in communication systems. An example method may comprise: receiving, by a processing device, a first subscriber identifier and a second subscriber identifier, wherein the first subscriber identifier identifies a subscriber of a first communication system; producing a third subscriber identifier based on the first subscriber identifier and the second subscriber identifier, wherein the third subscriber identifier identifies a subscriber of a second communication system; and causing a communication session to be established between the subscriber of the first communication system and the subscriber of the second communication system.

### TECHNICAL FIELD

The present disclosure is generally related to communication systems, and is more specifically related to identifying subscribers engaging in a mutual communication session.

### BACKGROUND

Various communication systems use a wide range of mechanisms for identifying system subscribers. For example, in a public switched telephone network (PSTN), a subscriber may be identified by a phone number compliant with ITU-T E.163/E.164 standards. In a voice-over-IP (VOIP) private network, a subscriber may be identifier by a user identifier, an E.163/E.164 phone number, and/or IP address of the subscriber's terminal equipment. These and various other methods of subscriber identification are based on assigning a unique identifier out of a pre-defined finite set of available identifiers.

### BRIEF DESCRIPTION OF THE DRAWINGS

The present disclosure is illustrated by way of examples, and not by way of limitation, and may be more fully understood with references to the following detailed description when considered in connection with the figures, in which:

FIGS. 1 and 3 depict high-level component diagrams of illustrative examples of distributed computer systems operating in accordance with one or more aspects of the present disclosure;

FIGS. 2 and 4 depict illustrative example of virtual subscriber mapping data structures employed by distributed computer systems illustrated by FIGS. 1 and 3, respectively;

FIGS. 5-6 depict flow diagrams of example methods for using virtual subscriber identifiers, in accordance with one or more aspects of the present disclosure; and

FIG. 7 depicts a block diagram of an illustrative computer system operating in accordance with the examples of the present disclosure.

### DETAILED DESCRIPTION

Described herein are methods and systems for using virtual subscriber identifiers in communication systems. “Communication system” herein shall refer to a distributed system comprising terminal equipment and packet and/or circuit switching equipment configured to provide communication sessions between two or more terminal equipment devices. Examples of terminal equipment include phone sets, smartphones, personal computers, general purpose computer systems with or without user interfaces, etc.

Examples of communication systems include various combinations of PSTN phone systems, VOIP-based phone systems, cellular phone systems and/or IP networks. Communication system can recursively include other communication systems. For example, a wide area IP network may include multiple backbone and local area IP networks. In another example, a hybrid phone system may include a VOIP system and a PSTN system. In a further example, a global PSTN system may include multiple regional PSTN systems.

“Communication session” herein shall refer to a physical or virtual channel between two or more terminal devices facilitating unidirectional or multi-directional data exchange (in the form of datagrams, voice streams, video streams, etc.) between those terminal devices. “Communication system subscriber” herein shall refer to a user or computer system employing the communication system for establishing a communication session with another communication system subscriber.

“Computer system” herein shall refer to a system comprising a processor, a memory device, and at least one communication interface. “Processor” herein shall refer to a device capable of executing instructions encoding arithmetic, logical, or I/O operations. In one illustrative example, a processor may implement Von Neumann architectural model including an arithmetic logic unit (ALU), a control unit, and a plurality of registers. In illustrative examples, a processor may be implemented as a single integrated circuit, two or more integrated circuits, or may be a component of a multi-chip module (e.g., in which individual microprocessor dies are included in a single integrated circuit package and hence share a single socket). “Memory device” herein shall refer to a volatile or non-volatile memory device, such as RAM, ROM, EEPROM, or any other device capable of storing data. “Communication interface” herein shall refer to a device configured to route binary data between a processor and an external device.

Communication systems may implement a wide variety of mechanisms for identifying system subscribers. For example, in a public switched telephone network (PSTN), a subscriber may be identified by a phone number compliant with ITU-T E.163/E.164 standards. In a voice-over-IP (VOIP) private network, a subscriber may be identifier by a user identifier, an E.163/E.164 phone number, and/or IP address of the subscriber's terminal equipment. These and various other methods of subscriber identification are based on assigning a unique identifier out of a pre-defined finite set of available identifiers. For example, a phone number to be assigned to a PSTN subscriber is selected from a pool of available E.163/E.164-compliant phone numbers for a given geographic region and/or organizational unit. In another example, an E.163/E.164-compliant phone number to be assigned to a subscriber of a VOIP system having a PSTN gateway is selected from a similar pool of available E.163/E.164-compliant phone numbers. In a further example, an IP address to be assigned to a computer user is selected from a pool of available IP addresses of a given Internet service provider (ISP).

The finiteness of the respective identifier pools makes the identifiers a potentially expensive and/or potentially exhaustible resource. The high price and potential exhaustion risks may, at least to some extent, be mitigated by effective assignment and usage models of the communication system subscriber identifiers. For example, an identifier may be leased to a subscriber for a pre-defined period of time.

While the identifier lease model may be useful in some situations (e.g., assigning an IP address to a portable computer in a public Wi-Fi network), it may nevertheless be impractical in other situations (such as assigning a phone number to a phone system subscriber). Furthermore, even for scenarios which may rely upon the identifier lease model, the latter may only be effective if the maximum number of subscribers requesting identifiers in any given period of time is less than the cardinality of the respective identifier pool.

The present disclosure addresses the above noted and other deficiencies by introducing virtual subscriber identifiers to be employed by various communication systems. In certain implementations, a first communication system subscriber may have knowledge of a virtual identifier of a second communication system subscriber. The first subscriber may provide the virtual identifier to the communication system and request a communication session with the second subscriber. Responsive to receiving the request, the communication system may identify the second subscriber based on the combination of the first subscriber identifier and the virtual identifier provided by the second subscriber.

Various aspects of the above referenced methods and systems are described in details herein below by way of examples, rather than by way of limitation.

In an illustrative example, a VOIP server communicatively coupled to a VOIP/PSTN gateway may be employed in a call center. The call center operators may initiate phone calls to PSTN subscribers and expect that at least some of the operator initiated calls would result in a new call initiated by the called party. To improve the PSTN subscriber experience, it may be useful to enable the PST subscriber to directly dial the call center operator which engaged the PSTN subscriber in the initial phone call. However, assigning a permanent PSTN number to every call center operator may be very expensive. Assigning virtual PSTN numbers in accordance with one or more aspects of the present disclosure may significantly reduce the size of PSTN number pool necessary for the call center functioning, and thus reduce the associated costs.

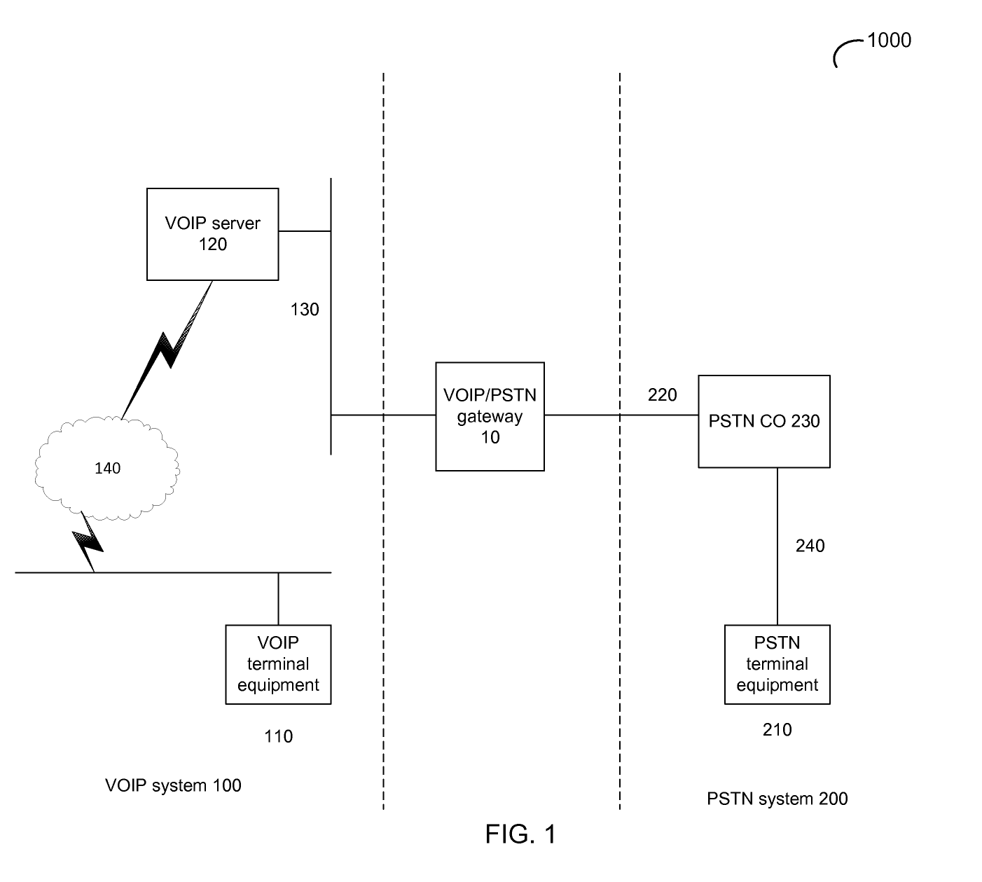

FIG. 1 depicts a high-level component diagram of one illustrative example of a distributed communication system 1000 in accordance with one or more aspects of the present disclosure. Communication system 1000 may comprise a VOIP communication system 100 and a PSTN communication system 200 interconnected by a VOIP/PSTN gateway 10. The latter may be configured to accept communication session requests (e.g., voice or facsimile call requests) initiated by VOIP or PSTN subscriber devices 110, 210 and route those requests to PSTN communication system 200 or VOIP communication system 100, respectively. VOIP communication system 100 may comprise one or more VOIP servers 120 communicatively coupled to VOIP/PSTN gateway 10 via one or more networks 130. Each network 130 may be provided by any combination of wide area, local area, public, or private networks, including wired or wireless networks. VOIP system subscribers may access the services provided by the VOIP system via a VOIP terminal device 110. The latter may be provided by a general purpose or specialized computer system including, e.g., a personal desktop computer, a notebook computer, a tablet computer, or a smart phone. VOIP terminal device 110 may be communicatively coupled to VOIP/PSTN gateway 10 via one or more networks 140. Each network 140 may be provided by any combination of wide area, local area, public, or private networks, including wired or wireless networks. While FIG. 1 illustrates VOIP server 120 and VOIP gateway 10 as two separate servers, the two functional components may, in certain implementations, be collocated in a single physical server.

On the PSTN side, VOIP/PSTN gateway 10 may be communicatively coupled, via one or more circuit switched networks 220 to a PSTN central office 230. Subscriber terminal equipment 210 may be communicatively coupled to PSTN central office 230 via one or more circuit switched trunks 240.

In certain implementations, for a new communication session initiated by a VOIP phone system subscriber with a PSTN subscriber, the VOIP server may assign a virtual subscriber identifier (represented by a phone number reachable from the PSTN network) to the VOIP system subscriber, using one of the virtual identifier assignment mechanisms described herein below. The VOIP server may then store, in a memory data structure 150, the mapping of the identifier of the PSTN subscriber 210 (i.e., the called party) to the combination of the identifier of the VOIP subscriber 110 (the calling party) and the virtual subscriber identifier automatically assigned to VOIP subscriber 110 by VOIP server 120.

Memory data structure 150 may be stored in a non-volatile memory (e.g., a flash memory or a disk-based storage). In certain implementations, memory data structure 150 may be stored in one or more relational database tables, and may be indexed by one or more fields.

In certain implementations, VOIP server 120 may, before assigning a new virtual subscriber identifier to VOIP subscriber 110, look up in memory data structure 150 the combination of the VOIP subscriber identifier (the calling party) and the PSTN subscriber identifier (the called party). Should a record comprising the above described combination be found in memory data structure 150, VOIP server 120 may, instead of assigning a new virtual subscriber identifier, retrieve the virtual subscriber identifier mapped to the above described combination.

The VOIP server may then forward to VOIP/PSTN gateway 10 a request to initiate a communication session with PSTN subscriber 210. The request may comprise the PSTN subscriber (i.e., the called party) identifier and the Calling Line Identifier (CLI) represented by the virtual subscriber identifier that has been newly assigned or retrieved from the memory data structure. In the course of establishing the communication session pursuant to the received request, VOIP/PSTN gateway 10 would provide the virtual subscriber as the Calling Line Identifier (CLI) to the PSTN infrastructure, which may forward the CLI to the PSTN subscriber (i.e., the called party).

Upon receiving the communication session initiation request (e.g., by the phone ringing) the PSTN subscriber may accept, explicitly decline, or ignore the request. Irrespectively of whether the request has been accepted, declined, or ignored, the PSTN subscriber may memorize the received CLI value as the PSTN number to reach VOIP subscriber 110 and later use it as it would use any other PSTN phone number for initiating a communication session with the VOIP subscriber who was identified by the CLI value in the initial communication session request.

At any time after the above described mapping of the identifier of the PSTN subscriber 210 to the combination of the identifier of the VOIP subscriber 110 and the virtual subscriber identifier has been created and stored in memory data structure 150 by VOIP server 120, PSTN subscriber 210 may initiate a new communication session with VOIP subscriber 110, by dialing the previously memorized virtual subscriber identifier. Upon receiving the session initiation request from PSTN subscriber 210, central office 230 may route the call, based on the PSTN number that was dialed, to VOIP/PSTN gateway 10. The latter may transmit to VOIP server 120 a session initiation request comprising the called party identifier represented by the virtual PSTN number assigned to VOIP subscriber 110 and the Calling Line Identifier (CLI) represented by the identifier of the PSTN subscriber 210.

Responsive to receiving the communication session initiation request, VOIP server 120 may look up, in memory data structure 150, the VOIP subscriber identifier corresponding to the combination of the PSTN subscriber identifier (the calling party) 210 and the virtual PSTN number (the number dialed by the PSTN subscriber). Should the look up succeed, VOIP server 120 may establish a communication session between the PSTN subscriber and the VOIP subscriber identified by the VOIP subscriber identifier retrieved from memory data structure 150. Should the look up fail, VOIP server 120 may abort the attempted communication session or redirect the attempted call to a subscriber identified by a pre-defined or dynamically determined communication system subscriber identifier.

Importantly, in the above described scenario, both the VOIP subscriber and the PSTN subscriber may be agnostic of the underlying infrastructure and the above described mechanism of assigning the virtual PSTN phone number to the VOIP subscriber. The VOIP subscriber would just dial the PSTN subscriber's phone number for establishing the initial communication session, and the PSTN subscriber would use the CLI value to place a new call to the VOIP subscriber, exactly as the CLI value would be used for placing a return call to any other party.

As noted herein above, for a new communication session initiated by a VOIP phone system subscriber with a PSTN subscriber, the VOIP server may, responsive to ascertaining that a virtual subscriber identifier has not already been assigned to the combination of the VOIP subscriber and the PSTN subscriber, assign a new virtual subscriber identifier (represented by a phone number reachable from the PSTN network) to the VOIP system subscriber. The triplet comprising the PSTN subscriber identifier, the VOIP subscriber identifier, and the virtual subscriber identifier assigned to the VOIP subscriber may be stored in a memory data structure.

The VOIP server may employ a variety of methods of selecting the virtual subscriber identifier to be assigned to the VOIP subscriber.

In an illustrative example, the VOIP server may assign the same virtual subscriber identifier to all VOIP subscribers, provided that the virtual subscriber identifier combined with the identifier of the PSTN subscriber (the called party) uniquely identifies the VOIP system subscriber, thus allowing the return call initiated by the PSTN subscriber be routed to the VOIP subscriber. Should the VOIP server determine that the combination of the PSTN subscriber identifier (i.e., the called party PSTN number) and the virtual subscriber identifier has already been mapped to another VOIP system subscriber, a next available virtual subscriber identifier may be retrieved from the pool of virtual subscriber identifiers.

Should no available virtual subscriber identifiers be found in the pool of virtual subscriber identifiers, the VOIP system server may, in certain implementations, retrieve the least recently used virtual subscriber identifier and remove, from the memory data structure, the record associating that virtual subscriber identifier with another VOIP system subscriber. The least recently used virtual subscriber identifier may then be assigned to the combination of the PSTN subscriber identifier (i.e., the called party PSTN number) and the VOIP subscriber identifier (the calling party). In certain implementations, to facilitate the retrieval of the least recently used virtual subscriber identifier, the memory data structure may store, for each recorded triplet of subscriber identifiers, a timestamp reflecting the time of the triplet recording.

In certain implementations, the mapping of a virtual subscriber identifier to the VOIP subscriber identifier may exist indefinitely. The mapping may be destroyed when a least recently used virtual subscriber identifier is retrieved, as described herein above. Alternatively, the mapping may be created for a pre-defined or configurable period of time, and may be automatically destroyed upon timeout expiration, returning the virtual subscriber identifier to the pool of available subscriber identifiers.

The above described method of virtual subscriber identifiers allocation provides for efficient usage of a relatively small pool of virtual subscriber identifiers, without requiring a permanent assignment of a unique PSTN number to every VOIP system subscriber.

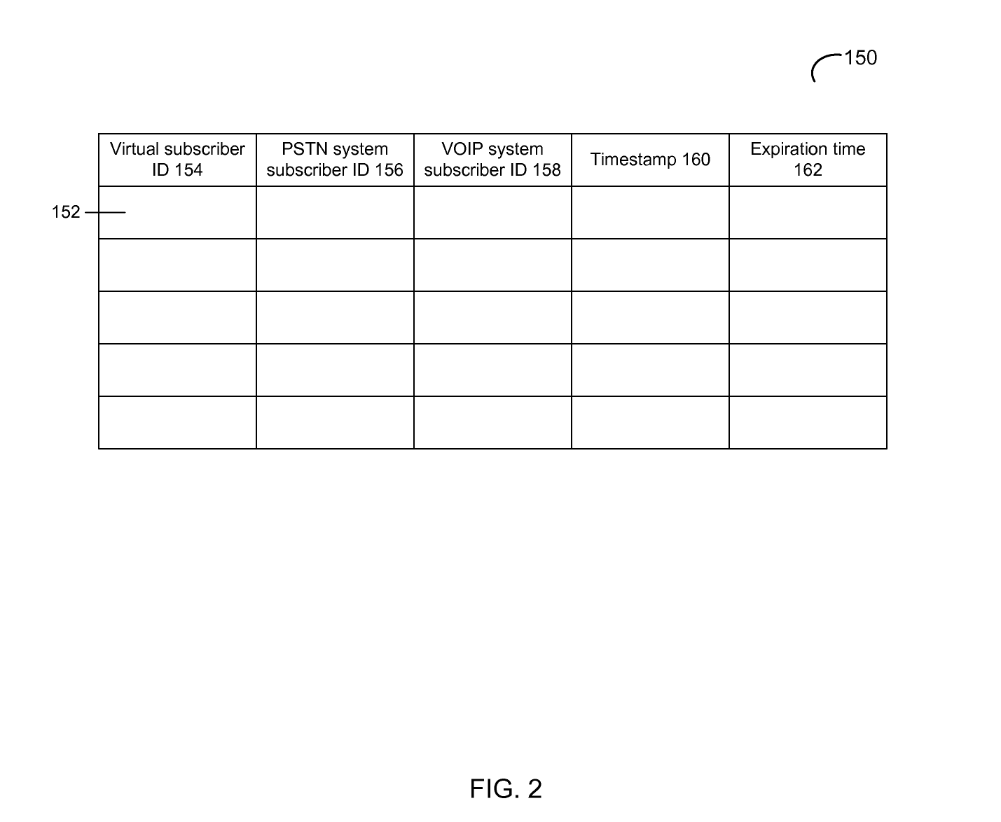

FIG. 2 schematically illustrates an example of the virtual subscriber mapping data structure employed by the distributed computer system of FIG. 1. Data structure 150 may be provided by a rectangular table (stored as a relational database table, a two-dimensional array, a list of tuples, etc.) comprising a plurality of rows. Each row 152 represent, for a virtual subscriber identifier 154 the associated PSTN system subscriber identifier 156 and VOIP system subscriber identifier 158. In certain implementations, each row may further comprise a timestamp 160 reflecting the time of creating the virtual subscriber identifier mapping to the VOIP system subscriber and PSTN system subscriber. In certain implementations, each row may further comprise an expiration time 162 reflecting the time of the mapping expiration.

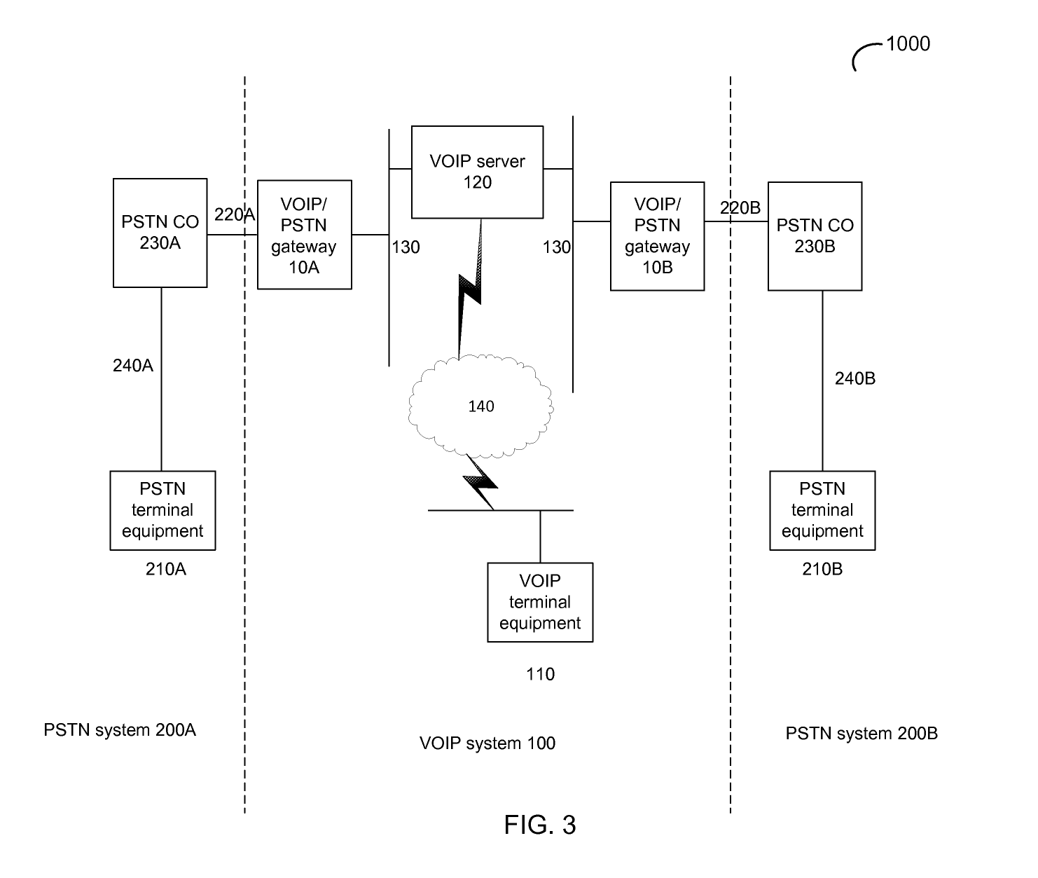

FIG. 3 depicts a high-level component diagram of another illustrative example of a distributed communication system 1000 in accordance with one or more aspects of the present disclosure. A VOIP server communicatively coupled to two or more VOIP/PSTN gateways may be employed for bridging two or more PSTN networks (e.g., national PSTN networks). A PSTN subscriber may obtain a virtual subscriber identifier represented by a PSTN phone number in another PSTN network, and register one or more identifiers of PSTN subscriber that are expected to initiate phone calls to the newly created virtual subscriber identifier. The VOIP server may store, in a memory data structure, one or more triplets comprising a virtual subscriber identifier represented by a virtual phone number, and identifier of a first PSTN subscriber who is expected to receive calls via the virtual phone number, and the identifier of a second PSTN subscriber who is expected to make calls to the first PSTN subscriber using the virtual phone number.

For example, a PSTN subscriber residing in Paris may obtain a virtual subscriber identifier provided by a PSTN phone number having a country code and area code of Sydney, and register one or more phone numbers that are expected to initiate phone calls to the Sydney virtual number. Then, a phone call initiated from one of the registered phone numbers to the Sydney virtual number will be routed by the VOIP infrastructure, transparently to both the calling and called parties, to the Paris PSTN number. Only the calls initiated by the pre-registered PSTN subscribers would reach the Paris PSTN number.

The above described arrangement may be useful, e.g., for a business based on one country and having a customer base or a workforce in another country, or for an individual residing in one country and having friends or relatives in another country. In the above describer scenario, the calling parties would dial local or long distance phone numbers, thus avoiding international calling PSTN costs. Assigning virtual PSTN numbers in accordance with one or more aspects of the present disclosure allows spreading the cost associated with obtaining a phone number in a given PSTN network against two or more users, thus significantly reducing the total service cost.

As schematically illustrated by FIG. 3, communication system 1000 may comprise a VOIP communication system 100 and two or more PSTN communication systems 200A-200B. Each PSTN communication system 200 may be interconnected with VOIP communication system 100 by a respective VOIP/PSTN gateway 10A-10B. Each VOIP/PSTN gateway 10 may be configured to accept communication session requests (e.g., voice or facsimile call requests) initiated by PSTN subscriber devices 210A-210B and route those requests to VOIP communication system 100. Each VOIP/PSTN gateway 10 may be further configured to accept communication session requests (e.g., voice or facsimile call requests) initiated by VOIP communication system 100 and route those requests to PSTN subscriber devices 210A-210B.

VOIP communication system 100 may comprise one or more VOIP servers 120 communicatively coupled to VOIP/PSTN gateways 10A-10B via respective networks 130A-130B. Each network 130 may be provided by any combination of wide area, local area, public, or private networks, including wired or wireless networks. VOIP system subscribers may access the services provided by the VOIP system via a VOIP terminal device 110. The latter may be communicatively coupled to VOIP/PSTN gateway 10 via one or more networks 140. Each network 140 may be provided by any combination of wide area, local area, public, or private networks, including wired or wireless networks.

On the PSTN sides, VOIP/PSTN gateway 10 may be communicatively coupled, via one or more circuit switched networks 220 to a respective PSTN central office 230A-230B. Subscriber terminal equipment 210A-210B may be communicatively coupled to a respective PSTN central office 230A-230B via one or more circuit switched trunks 240A-240B.

In an illustrative example, a PSTN subscriber 210A may initiate (e.g., via a suitable user interface) a virtual identifier assignment request comprising one or more identifiers of PSTN subscribers 210B who are expected to initiate calls to the requesting PSTN subscriber. Responsive to receiving the virtual identifier assignment request, the VOIP server may assign a virtual subscriber identifier (represented by a phone number reachable from the second PSTN network) to the requesting PSTN subscriber, using one of the virtual identifier assignment mechanisms described herein below.

For each PSTN subscriber 210B specified in the virtual identifier assignment request as an expected calling party, the VOIP server may then store, in a memory data structure 350, a mapping of the identifier of the PSTN subscriber 210A (the virtual identifier requestor) to the combination of the identifier of the PSTN subscriber 210B (the party expected to initiate phone calls to PSTN subscriber 210A) and the virtual subscriber identifier assigned to PSTN subscriber 210A.

Memory data structure 350 may be stored in a non-volatile memory (e.g., a flash memory or a disk-based storage). In certain implementations, memory data structure 150 may be stored in one or more relational database tables, and may be indexed by one or more fields.

In certain implementations, VOIP server 120 may, before assigning a new virtual subscriber identifier to PSTN subscriber 210A, look up in memory data structure 350 the combination of the requestor identifier and PSTN subscriber identifier 210B (the expected calling party). Should a record comprising the above described combination be found in memory data structure 350, VOIP server 120 may retrieve the virtual subscriber identifier mapped to the above described combination, instead of assigning a new virtual subscriber identifier.

At any time after the above described mapping of the identifier of PSTN subscriber 210B to the combination of the identifier of PSTN subscriber 210A and the virtual subscriber identifier has been created and stored in memory data structure 150 by VOIP server 120, PSTN subscriber 210B may initiate a new communication session with PSTN subscriber 210A, by dialing the virtual subscriber identifier. Upon receiving the session initiation request from PSTN subscriber 210B, central office 230B may route the call, based on the PSTN number that was dialed, to VOIP/PSTN gateway 10B. The latter may transmit to VOIP server 120 a session initiation request comprising the called party identifier represented by the virtual PSTN number assigned to PSTN subscriber 210A and the Calling Line Identifier (CLI) represented by the identifier of PSTN subscriber 210B.

Responsive to receiving the communication session initiation request, VOIP server 120 may look up, in memory data structure 350, the subscriber identifier corresponding to the combination of PSTN subscriber identifier (the calling party) 210B and the virtual PSTN number (the number dialed by PSTN subscriber 210B). Should the look up succeed, VOIP server 120 may, via VOIP/PSTN gateway 10A, establish a communication session between PSTN subscriber 210B and PSTN subscriber 210A identified by the subscriber identifier retrieved from memory data structure 350.

Should the look up fail, VOIP server 120 may abort the attempted communication session or redirect the attempted call to a subscriber identified by a pre-defined or dynamically determined communication system subscriber identifier.

The above described method of virtual subscriber identifiers allocation provides for efficient usage of a relatively small pool of virtual subscriber identifiers, without requiring a permanent assignment of a unique PSTN number to every subscriber.

In certain implementations, each of the two PSTN subscribers may have a virtual number assigned in the other subscriber's PSTN network. In the above describer example, the PSTN subscriber residing in Paris may obtain a virtual subscriber identifier provided by a PSTN phone number having a country code and area code of Sydney, and register a phone number of a Sydney-based PSTN subscriber that is expected to initiate phone calls to the Sydney virtual number. Conversely, the Sydney-based PSTN subscriber may obtain a virtual subscriber identifier provided by a PSTN phone number having a country code and area code of Paris, and register a phone number of the Paris-based PSTN subscriber that is expected to initiate phone calls to the Paris virtual number. Then, phone calls initiated from the registered Sydney phone number to the Sydney virtual number will be routed by the VOIP infrastructure, transparently to both the calling and called parties, to the Paris PSTN number, while phone calls initiated from the registered Paris phone number to the Paris virtual number will be routed by the VOIP infrastructure, transparently to both the calling and called parties, to the Sydney PSTN number.

Only the calls initiated by the pre-registered PSTN subscribers would reach the respective Paris and Sydney PSTN numbers, thus allowing re-use of virtual subscriber identifiers (e.g., Paris and Sydney-based phone numbers) among a plurality of subscribers.

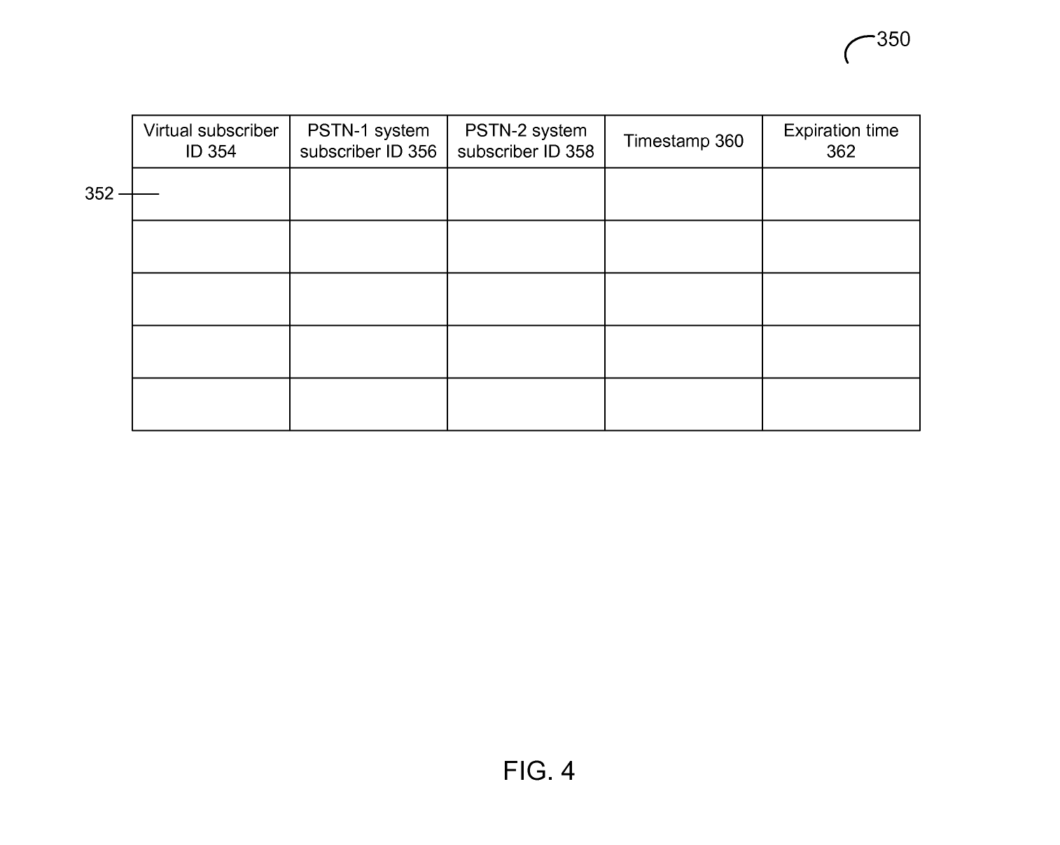

FIG. 4 schematically illustrates an example of the virtual subscriber mapping data structure employed by the distributed computer system of FIG. 3. Data structure 350 may be provided by a rectangular table (stored as a relational database table, a two-dimensional array, a list of tuples, etc.) comprising a plurality of rows. Each row 352 represent, for a virtual subscriber identifier 354 the associated identifier of the first PSTN system subscriber identifier 356 (the expected calling party) and the identifier of the second PSTN system subscriber identifier 358 (the destination party). In certain implementations, each row may further comprise a timestamp 360 reflecting the time of creating the virtual subscriber identifier mapping. In certain implementations, each row may further comprise an expiration time 362 reflecting the time of the virtual subscriber identifier mapping expiration.

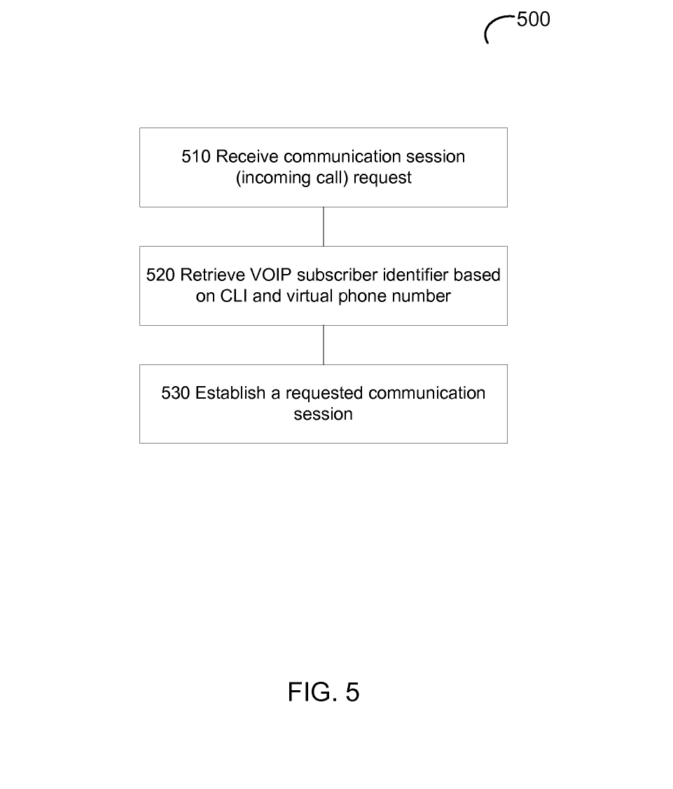

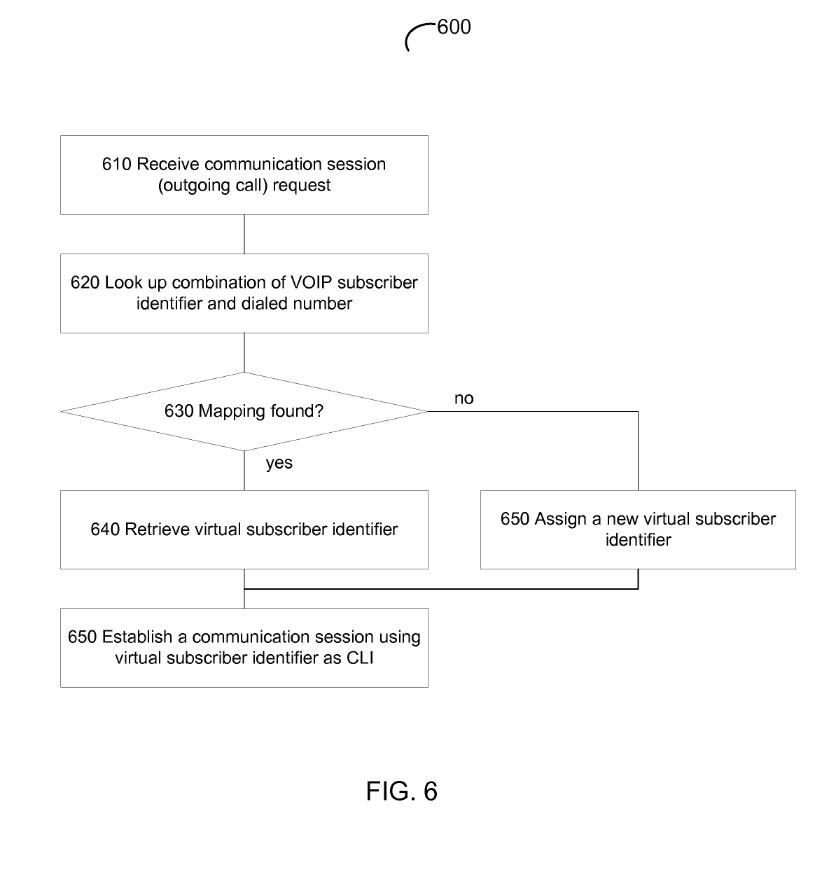

Example methods of assigning and using virtual subscriber identifiers, in accordance with one or more aspects of the present disclosure, are described herein below with references to flow diagrams of FIGS. 5 and 6.

FIG. 5 depicts a flow diagram of an illustrative example of a method 500 for using a virtual subscriber identifier for establishing a communication system between subscribers of two communication systems. Method 500 may be performed by VOIP server 120 of FIG. 1 responsive to receiving an incoming call to a VOIP subscriber from a PSTN system subscriber using the virtual subscriber identifier represented by a PSTN phone number that has been previously assigned to the VOIP system subscriber. Alternatively, method 500 may be performed by VOIP server 120 of FIG. 3 responsive to receiving an incoming call to a first PSTN subscriber from a second PSTN system subscriber using the virtual subscriber identifier represented by a PSTN phone number that has been previously assigned to the first system subscriber.

Method 500 and/or each of its individual functions, routines, subroutines, or operations may be performed by one or more processors of the computer system (e.g., VOIP server 120 of FIG. 1 or FIG. 3) executing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other.

At block 510, the VOIP server may receive a communication session request comprising a first subscriber identifier and a second (virtual) subscriber identifier. In an illustrative example, the communication session request may be represented by an incoming call from a PSTN system subscriber to a VOIP system subscriber. The first subscriber identifier may be provided by a CLI and may identify a subscriber of a first communication system. The second subscriber identifier may be represented by a virtual subscriber identifier that has previously been assigned to a subscriber of the second communication system, as described in more details herein above.

At block 520, the VOIP server may produce the identifier of the subscriber of the second communication system, by looking up a memory data structure mapping the combination of virtual subscriber identifier and a calling party identifier, as described in more details herein above. In an illustrative example, the VOIP server may look up the memory data structure for an identifier of a VOIP system subscriber mapped to the combination received CLI and the virtual phone number dialed by the calling party to produce an identifier of a VOIP system subscriber.

At block 530, the VOIP server may cause a communication session to be established between the subscriber of the first communication system and the subscriber of the second communication system.

FIG. 6 depicts a flow diagram of an illustrative example of a method 600 for assigning a virtual subscriber identifier to a communication system subscriber, in accordance with one or more aspects of the present disclosure. Method 600 may be performed by VOIP server 120 of FIG. 1 responsive to receiving an outgoing call by a call center operator to an external PSTN subscriber. Method 600 and/or each of its individual functions, routines, subroutines, or operations may be performed by one or more processors of the computer system (e.g., VOIP server 120 of FIG. 1) executing the method. In certain implementations, method 600 may be performed by a single processing thread. Alternatively, method 600 may be performed by two or more processing threads, each thread executing one or more individual functions, routines, subroutines, or operations of the method. In an illustrative example, the processing threads implementing method 600 may be synchronized (e.g., using semaphores, critical sections, and/or other thread synchronization mechanisms). Alternatively, the processing threads implementing method 600 may be executed asynchronously with respect to each other.

At block 610, the VOIP server may receive a communication session request comprising a first subscriber identifier and a second (virtual) subscriber identifier. In an illustrative example, the communication session request may be represented by an outgoing call from a VOIP system subscriber to a PSTN system subscriber. The first subscriber identifier may be provided by a VOIP system subscriber identifier, and the second subscriber identifier may be provided by a PSTN phone number of the called party.

At block 620, the VOIP server may look up in a memory data structure the combination of the VOIP subscriber identifier (the calling party) and the PSTN subscriber identifier (the PSTN number dialed by the VOIP subscriber).

Responsive to determining, at block 630, that a matching virtual subscriber identifier has been found, the VOIP server may, at block 640, retrieve the virtual subscriber identifier mapped to the above described combination of the VOIP subscriber identifier and the called party identifier.

Alternatively, at block 650, the VOIP server may retrieve a virtual subscriber identifier from a pool of available virtual subscriber identifiers, as described in more details herein above, and create a mapping of the virtual subscriber identifier and the above described combination of the VOIP subscriber identifier and the called party identifier.

At block 660, the VOIP server may cause a communication session to be established between the VOIP system subscriber and the PSTN system subscriber. The virtual subscriber identifier assigned to the VOIP system subscriber may be forwarded to the PSTN infrastructure as the CLI.

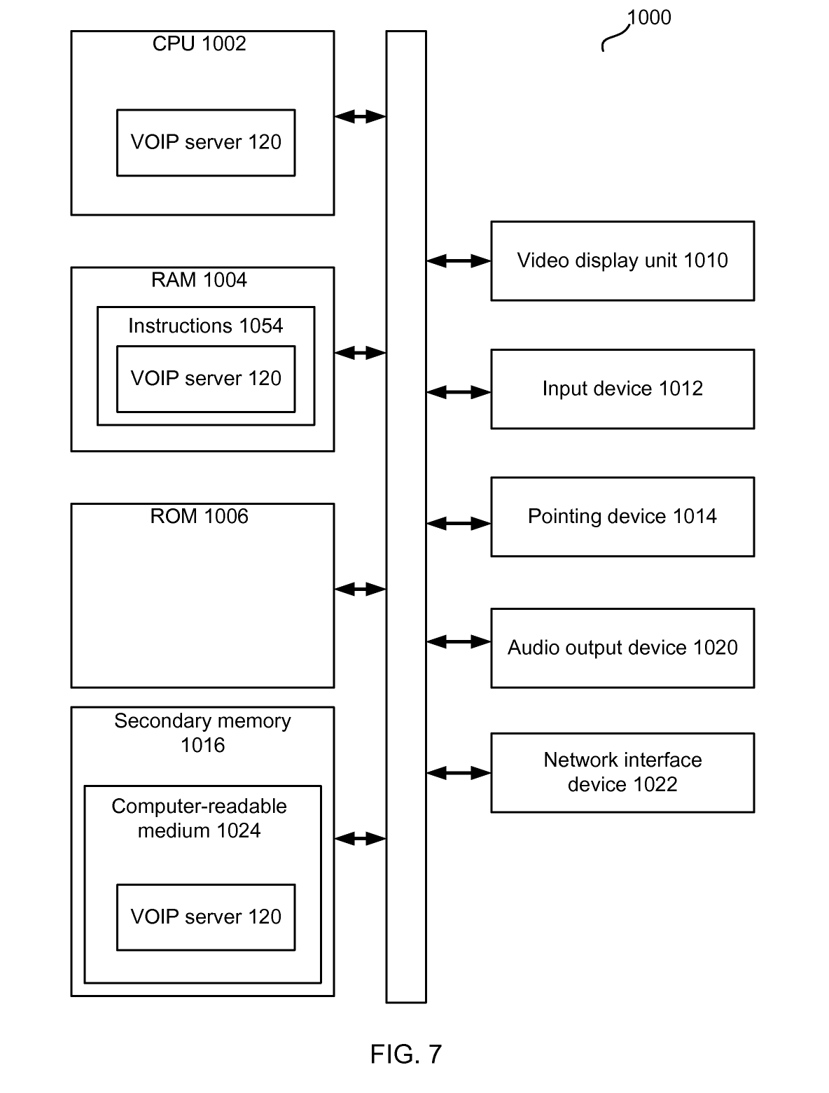

FIG. 7 depicts an example computer system 1000 within which a set of instructions, for causing the computer system to perform any one or more of the methods described herein, may be executed. In certain implementations, computer system 1000 may correspond to the VOIP server 120 of FIG. 1 or FIG. 3.

In an illustrative example, computer system 1000 may be connected (e.g., via a network, such as a Local Area Network (LAN), an intranet, an extranet, or the Internet) to other computer systems. Computer system 1000 may operate in the capacity of a server or a client computer in a client-server environment, or as a peer computer in a peer-to-peer or distributed network environment. Computer system 1000 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1000 may include a physical processor 1002, a volatile memory 1004 (e.g., random access memory (RAM)), a non-volatile memory 1006 (e.g., read-only memory (ROM) or electrically-erasable programmable ROM (EEPROM)), and a secondary memory 1016 (e.g., a data storage device), which may communicate with each other via a bus 1008.

Processor 1002 may be provided by one or more physical processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1000 may further include a network interface device 1022. Computer system 1000 also may include a video display unit 1010 (e.g., an LCD), an alphanumeric input device 1012 (e.g., a keyboard), a pointing device 1014 (e.g., a mouse), and an audio output device 1020 (e.g., a speaker).

Secondary memory 1016 may include a non-transitory computer-readable storage medium 1024 on which may be stored instructions of methods 500, 600 for employing virtual subscriber identifiers in communication systems. Instructions of methods 500, 600 may also reside, completely or partially, within main memory 1004 and/or within processor 1002 during execution thereof by computer system 1000, hence, main memory 1004 and processor 1002 may also constitute machine-readable storage media.

While computer-readable storage medium 1024 is shown in the illustrative example as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any non-transitory medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

Unless specifically stated otherwise, terms such as “updating”, “identifying”, “determining”, “sending”, “assigning”, or the like, refer to actions and processes performed or implemented by computer systems that manipulates and transforms data represented as physical (electronic) quantities within the computer system's registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computer system selectively programmed by a computer program stored in the computer system. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method operations. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method comprising:
receiving, by a processing device, a first subscriber identifier and a second subscriber identifier, wherein the first subscriber identifier identifies a subscriber of a first communication system;
producing a third subscriber identifier based on the first subscriber identifier and the second subscriber identifier, wherein the third subscriber identifier identifies a subscriber of a second communication system; and
causing a communication session to be established between the subscriber of the first communication system and the subscriber of the second communication system.

2. The method of claim 1, wherein the second subscriber identifier is provided by a virtual identifier.

3. The method of claim 1, wherein producing the third identifier comprises retrieving the third subscriber identifier from a memory data structure associating the third subscriber identifier with a combination of the first subscriber identifier and the second subscriber identifier.

4. The method of claim 1, wherein at least one of: the first subscriber identifier, the second subscriber identifier, or the third subscriber identifier comprises a public switched telephone network (PSTN) phone number.

5. The method of claim 1, wherein at least one of: the first subscriber identifier, the second subscriber identifier, or the third subscriber identifier comprises a device identifier identifying a terminal device of a communication system.

6. The method of claim 1, wherein at least one of: the first subscriber identifier, the second subscriber identifier, or the third subscriber identifier comprises a user identifier identifying a user of a distributed computer system.

7. The method of claim 1, wherein the first communication system is provided by a PSTN network and the second communication system is provided by a VOIP network.

8. The method of claim 1, wherein the first communication system is provided by a first PSTN network and the second communication system is provided by a second PSTN network.

9. The method of claim 1, further comprising:
receiving the first subscriber identifier and the third subscriber identifier;
associating, by a memory data structure, the first subscriber identifier and the second subscriber identifier with the third subscriber identifier; and
causing a communication session to be established between the subscriber of the second communication system and the subscriber of the first communication system.

10. A system comprising:
a memory; and
one or more physical processors, coupled to the memory, to:
receiving a first subscriber identifier and a second subscriber identifier, wherein the first subscriber identifier identifies a subscriber of a first communication system;
producing a third subscriber identifier based on the first subscriber identifier and the second subscriber identifier, wherein the third subscriber identifier identifies a subscriber of a second communication system; and
causing a communication session to be established between the subscriber of the first communication system and the subscriber of the second communication system.

11. The system of claim 10, wherein the second subscriber identifier is provided by a virtual identifier.

12. The system of claim 10, wherein at least one of: the first subscriber identifier, the second subscriber identifier, or the third subscriber identifier comprises a public switched telephone network (PSTN) phone number.

13. The system of claim 10, wherein at least one of: the first subscriber identifier, the second subscriber identifier, or the third subscriber identifier comprises a device identifier identifying a terminal device of a communication system.

14. The system of claim 10, wherein at least one of: the first subscriber identifier, the second subscriber identifier, or the third subscriber identifier comprises a user identifier identifying a user of a distributed computer system.

15. The system of claim 10, wherein the first communication system is provided by a PSTN network and the second communication system is provided by a VOIP network.

16. The system of claim 10, wherein the first communication system is provided by a first PSTN network and the second communication system is provided by a second PSTN network.

17. A computer-readable non-transitory storage medium comprising executable instructions that, when executed by a computer system, cause the computer system to perform operations, comprising:
receiving a first subscriber identifier and a second subscriber identifier, wherein the first subscriber identifier identifies a subscriber of a first communication system;
producing a third subscriber identifier based on the first subscriber identifier and the second subscriber identifier, wherein the third subscriber identifier identifies a subscriber of a second communication system; and
causing a communication session to be established between the subscriber of the first communication system and the subscriber of the second communication system.

18. The computer-readable non-transitory storage medium of claim 17, wherein the second subscriber identifier is provided by a virtual identifier.

19. The computer-readable non-transitory storage medium of claim 17, wherein producing the third identifier comprises retrieving the third subscriber identifier from a memory data structure associating the third subscriber identifier with a combination of the first subscriber identifier and the second subscriber identifier.

20. The computer-readable non-transitory storage medium of claim 17, further comprising executable instructions that, when executed by a computer system, cause the computer system to perform operations, comprising:
receiving the first subscriber identifier and the third subscriber identifier;
associating, by a memory data structure, the first subscriber identifier and the second subscriber identifier with the third subscriber identifier; and
causing a communication session to be established between the subscriber of the second communication system and the subscriber of the first communication system.
